(19) United States
(12) Patent Application Publication
(10) Pub. No.: US 2014/0025609 A1
(43) Pub. Date: Jan. 23, 2014

(54) Methods and Arrangements For Creating Customized Recommendations

(71) Applicants: Rickard Coster, Hagersten (SE); Vincent Huang, Sollentuna (SE)

(72) Inventors: Rickard Coster, Hagersten (SE); Vincent Huang, Sollentuna (SE)

(73) Assignee: Telefonaktiebolaget L M Ericsson (publ), Stockholm (SE)

(21) Appl. No.: 14/009,849

(22) PCT Filed: Apr. 5, 2011
(86) PCT No.: PCT/SE2011/050400

§ 371 Date: Oct. 4, 2013

(51) Int. Cl. G06N 5/02; G06N 99/00

(52) U.S. Cl. CPC G06N 5/02; G06N 99/005
USPC 706/12; 706/46

(57) ABSTRACT

A method and arrangement for creation of a customized recommendation of items in a user device (200) in communication with a recommendation system (202). The recommendation system obtains (2:2a) ratings of items for a public recommendation based on public user data (202a) and obtains (2:2b) attribute-related weight information for said items with item-specific weight values for a plurality of attributes pertaining to user characteristics. The ratings of items in the public recommendation and the weight information are sent (2:3) to the user device which then modifies (2:4, 2:4a) the public recommendation into a customized recommendation by selecting attributes valid for a current user based on said private user data, and applying the weight values of the selected attributes only to the received ratings of items. The non-valid attributes are thus disregarded. Thereby, new item ratings are obtained which have been adapted to the characteristics of this particular user.

### TECHNICAL FIELD

The invention relates generally to methods and arrangements for creating customized recommendations of items based on personal information.

### BACKGROUND

Recently, various solutions and mechanisms have been developed for creating customized or “personalized” recommendations to users in a communication network, for consuming or otherwise using different products and services. It has become quite common to present recommendations of products and services that are offered for sale from a web-based shop or retailer to potential customers, where the recommendations have been somehow adapted to the customers. The adapted or customized recommendations may thus be presented to potential customers by various providers and suppliers of products and services, in order to achieve efficiency and yield of their marketing activities and offerings. Thereby, the customers will also be better served by receiving more relevant and interesting recommendations which could increase their general responsiveness to such recommendations.

In the following, the term “item” will be used here to represent any product, article, object or service in any field of use, that can be recommended to a potential customer for usage or consumption. The receiver of an item recommendation will be called “user” for short, and the term “user device” represents any communication entity used by a user for communicating with a recommendation system.

The recommendation systems of today typically employ a filtering mechanism or the like for extracting items of interest to recommend, which can basically be divided into content based filtering and collaborative filtering. The content based filtering is configured to determine items to recommend depending on information and characteristics of the items and/or the users, while the collaborative filtering is based on ratings made by the users for different items.

The ratings used in collaborative filtering may be either explicit or implicit. For example, a typical collaborative filtering algorithm determines items to recommend by comparing ratings of different items made by different users. Such a filtering mechanism may be either item-based by considering similarities of the item ratings, or user-based by considering similarities between the users having generated the ratings. By way of example, a typical recommendation could be: “customers who bought this product have also bought the following products . . . .”

In either case, in order to produce relevant and potentially interesting recommendations, information related to the individual users would be useful, such as demographic data as well as information on purchased items, ratings made, and so forth. Mostly, recommendation systems are employed by various online-based enterprises such as web shops, content providers and retailers, which the users can access over the Internet by means of computers and other communication terminals.

FIG. 1 illustrates how a recommendation of items can be made for a user 100 of, e.g., a mobile phone 100a or a PC (personal Computer) 100b, according to a conventional procedure. In a first shown action 1:1, a central recommendation system 102 collects information related to consumption and ratings of various items on a continuous basis. This type of information is typically available from a communication network 104 or the like which registers and stores such information, e.g. in the form of consumption logs and item ratings. In this example, the user 100 first sends a recommendation request to the recommendation system 102, in an action 1:2. In response thereto, system 102 creates a suitable recommendation of items, in an action 1:3, based on the collected item information and sends the recommendation to the user 100, in an action 1:4. Hopefully, items can be selected for the recommendation to be of some interest to the requesting user, if such information is available to the recommendation system 102.

It can be understood from the above that a recommendation system will be able to produce particularly relevant recommendations to individual users if it has access to personal information on the users, e.g. age, profession, interests, home address, and so forth. However, to generally protect user privacy, such personal information is typically not available for a recommendation system which only has access to more public information regarding the users' consumption activities and previously made ratings of items. As in the above action 1:1, this type of information is normally collected and maintained as statistics in more or less public databases without explicitly connecting that information to the individual users. No private information is thus stored in such public databases since it would compromise the privacy or confidentiality of the users. As a result, the recommendations that can be produced from this data are of more public nature which may be relevant for some users but not for others. It is thus a problem that private user data cannot be used for creating customized recommendations without sacrificing the privacy of the users, and that such private user data is generally not available to recommendation systems.

### SUMMARY

It is an object of the invention to address at least some of the problems and shortcomings outlined above. It is also an object to enable creation of customized recommendations of items with improved relevance to a particular user without sacrificing the user's privacy. It is possible to achieve these objects and others by using a method and an arrangement as defined in the attached independent claims.

According to one aspect, a method is provided in a recommendation system for enabling creation of a customized recommendation of items in a user device. In this method, the recommendation system obtains ratings of items for a public recommendation and obtains attribute-related weight information for the items. This weight information comprises item-specific weight values for a plurality of predefined attributes pertaining to user characteristics. The recommendation system then sends the ratings of items in the public recommendation and the weight information to the user device.

According to another aspect, an arrangement is provided in a recommendation system configured to enable creation of customized recommendations of items for a user of a user device. This arrangement comprises a first obtaining module adapted to obtain ratings of items for a public recommendation, and a second obtaining module adapted to obtain attribute-related weight information for the items. The weight information comprises item-specific weight values for a plurality of predefined attributes pertaining to user characteristics. This arrangement in the recommendation system further comprises a communication module adapted to send the ratings of items in the public recommendation and the weight information to the user device.

By using the method and arrangement above in the recommendation system, the user device is enabled to modify the public recommendation into a customized recommendation based on locally stored private user data and said weight information. A relevant customized recommendation can thus be created by taking private user data of the user into account locally in the device, while the user's privacy is maintained since the private user data never leaves the device.

The above method and arrangement in the recommendation system may be configured and implemented according to different optional embodiments. In one possible embodiment, the ratings of items in the public recommendation may be determined based on public user data including at least one of: consumption logs and previously registered item ratings. In another possible embodiment, the recommendation system also sends a combination function F to the user device with the public recommendation and weight information. Thereby, the user device is enabled to apply the weight values of selected attributes in the weight information to the received ratings of items according to the combination function F.

In other possible embodiments, the attribute-related weight information has been determined by means of data mining or statistic analysis of user-specific information on consumed and rated items. The recommendation system may also send the public recommendation and weight information in response to a recommendation request received from the user device. The recommendation system may further select a limited set of items for the public recommendation based on their ratings.

According to yet another aspect, a method is provided in a user device for creating a customized recommendation of items. In this method, the user device receives ratings of items in a public recommendation and attribute-related weight information for the items from a recommendation system. The weight information comprises item-specific weight values for a plurality of predefined attributes pertaining to user characteristics. The user device then modifies the public recommendation into a customized recommendation based on locally stored private user data and the weight information, and presents the customized recommendation, e.g. to a user.

According to another aspect, an arrangement is provided in a user device configured to create a customized recommendation of items. This arrangement comprises a communication module adapted to receive from a recommendation system ratings of items in a public recommendation and attribute-related weight information for the items, where the weight information comprises item-specific weight values for a plurality of predefined attributes pertaining to user characteristics. The arrangement in the user device further comprises a modifying module adapted to modify the public recommendation into a customized recommendation based on locally stored private user data and the weight information, and a presenting module adapted to present the customized recommendation.

The above method and arrangement in the user device may be configured and implemented according to different optional embodiments as well. In one possible embodiment, the user device creates the customized recommendation by selecting valid attributes out of the predefined attributes based on the private user data, and applies the weight values of the selected attributes in the weight information to the received ratings of items.

In another possible embodiment, the user device receives a combination function F with the public recommendation from the recommendation system, and applies the weight values of the selected attributes in the weight information to the received ratings of items according to the received combination function F.

Further possible features and benefits of this solution will become apparent from the detailed description below.

### BRIEF DESCRIPTION OF DRAWINGS

The invention will now be described in more detail by means of exemplary embodiments and with reference to the accompanying drawings, in which:

FIG. 1 is a communication scenario illustrating a conventional procedure for providing a recommendation of items, according to the prior art.

FIG. 2 is a block diagram illustrating how a customized recommendation of items can be made, according to some possible embodiments.

FIG. 3 is a flow chart illustrating procedures in a recommendation system and a user device for creating a customized recommendation of items, according to further possible embodiments.

FIG. 4 is a schematic diagram illustrating in more detail how a customized recommendation of items can be created, according to further possible embodiments.

FIG. 5 is a block diagram illustrating examples of a recommendation system and a user device, according to further possible embodiments.

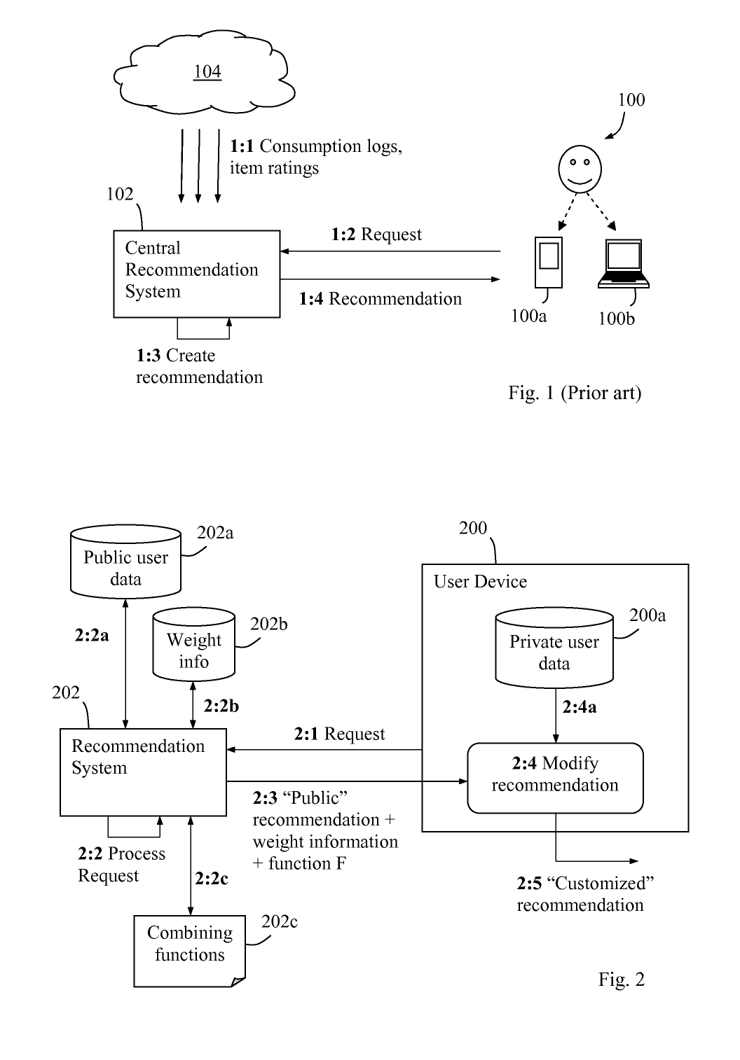

### DETAILED DESCRIPTION

Briefly described, a solution is provided to achieve a customized recommendation of items in a user device by applying private user data to a received public recommendation locally in the user device. Thereby, the private user data is not exposed outside the user device and privacy can be secured for the user while still achieving the customized recommendation. The user device receives the public recommendation from a central recommendation system along with weight information, which the device uses for creating the customized recommendation. This recommendation system may be a server or other entity with a recommendation engine or the like, which may be reside in a single node or be distributed over multiple nodes. In this description, the term “recommendation system” is used to represent any logical node, entity or function that is capable of producing a public recommendation and send the public recommendation together with weight information to the user device as follows.

Recommendations that have been adapted to individual users will be referred to as “customized” recommendations, in the sense that a customized recommendation is devised to potentially provide some value or interest to a particular targeted customer, regardless of whether he/she actually follows the recommendation or not. Alternatively, the term “personalized” could be used as equivalent to customized.

With reference to a communication scenario illustrated in FIG. 2, an example of how a customized recommendation of items can be created in a user device 200 in communication with a recommendation system 202 in accordance with this solution, will now be described. This procedure is explained by means of various actions performed by the recommendation system 202 and the user device 200, where each action may in practice involve one or more suitable processing operations and/or messages depending on the implementation.

In a first shown action 2:1, the recommendation system 202 receives a request for a recommendation sent from the user device 200. However, this action may be omitted in other cases and the following procedure may be initiated by the recommendation system 202 instead, e.g. when it is desirable to provide an offer of items for sale to the user in the form of an advertisement or the like presented to the user on the device. Another action 2:2 illustrates that the recommendation system 202 processes the request according to the following sub-actions 2:2a-c.

In one action 2:2a, the recommendation system 202 creates a public recommendation by obtaining ratings of items, wherein the item ratings are determined based on public user data that can be retrieved from a data storage 202a. As indicated above, item ratings may be determined from ratings made by the users for different items, either explicit or implicit, and from information regarding the users' consumption activities, both being regarded as public information. In this context, the recommendation is “public” in the sense that it is created from public user data but not private user data. In some cases, the public recommendation may be seen to represent an average recommendation of a large number of users, or even basically all users, e.g. if the recommendation is based on ratings made by those users and their consumption activities. The public user data from storage 202a may thus include at least one of: consumption logs and previously registered item ratings being collected and stored in data storage 202a. The management of public user data in storage 202a is however somewhat outside the scope of this solution.

In order to restrict the amount of information to handle, a limited number of items may be selected for the public recommendation according to some suitable item selection criterion. For example, a limited set of items may be selected for the public recommendation based on their ratings by ranking the items according to their ratings and selecting a preset number of items having the highest ratings, e.g. the 20 highest rated items. Further, the selection of items for the public recommendation may be based on the type or category of items which the user may specify in the request or in otherwise available preferences, and so forth.

In another action 2:2b, the recommendation system 202 also obtains attribute-related weight information for the items in the public recommendation from another data storage 202b. This weight information comprises item-specific weight values for a plurality of predefined attributes pertaining to different user characteristics. For example, these attributes may refer to age, gender, profession, interests, geographic residence, and so forth, and a set of such attributes have thus been defined as being more or less relevant for different items and can be used in this solution which is not limited to any particular attributes.

As said above, the weight information includes a weight value per attribute for each item, thus being “item-specific”. In more detail, the weight value indicates how relevant or pertinent a particular attribute is deemed for a certain item. By way of an illustrative example, if the item is the well-known film “Matrix” and the attribute is “age: 5-10 years”, the weight value of that attribute will likely be set quite low for item “Matrix”, while the weight value of attribute “age: 20-30 years” will be set rather high for that item.

It is assumed that such item-specific weight values have been predetermined for the predefined attributes and a collection of items, and that those weight values are available from storage 202b. This weight information may be built up gradually over time in storage 202b for a growing range of items and this solution makes use of that information. The attribute-related weight information may have been determined by means of data mining or statistic analysis of user-specific information on consumed and rated items.

In yet another action 2:2c, the recommendation system 202 may also select a “combining function F” from a collection of predefined combining functions 202c, which the user device 200 can use to modify the public recommendation into a customized recommendation. In short, the weight values shall be applied to the ratings of items according to the combination function F, which will be described in more detail later below. Alternatively, the user device 200 may use a predefined “default” function being locally stored in the device, for creating the customized recommendation such that it is not necessary to send any such function from system 202 to device 200.

When the processing of the request has been completed in the recommendation system 202 as described above, it sends the public recommendation with ratings of items together with the obtained attribute-related weight information for those items, and optionally also including the combination function F if used, to the user device 200 in an action 2:3. As mentioned above, the actions 2:2a, 2:2b and optionally 2:2c may be triggered otherwise than by a request from the device 200.

The user device 200 can now modify the received public recommendation into a customized recommendation based on locally stored private user data 200a and the received weight information, in a further action 2:4. In this action, the user device 200 basically applies the private user data to the public recommendation, illustrated in action 2:4a, by first selecting valid attributes out of the attributes of the received weight information, based on the private user data. In other words, the received weight values of the non-valid attributes are simply disregarded which contributes to the actual customization process in this solution.

The user device 200 then applies the received weight values of the selected attributes in the weight information to the ratings of items in the public recommendation. For example, when weight values have been received from system 202 for the attributes “age: 5-10 years” and “age: 20-30 years” for the item ‘Matrix’, the user device 200 can deduce from the private user data that this particular user is aged 27 years. As a result, the attribute “age: 20-30 years” will be selected but not the attribute “age: 5-10 years” which is disregarded, and the received weight values for attribute “age: 20-30 years” will be used for determining a new rating for ‘Matrix’ which is relevant for this user.

Thereby, the items will most likely get new ratings which are different from the ratings in the public recommendation and more closely related to the user's assumed personal preferences and needs, which is thus achieved by the selection of relevant attributes. As a result, the items can be ranked differently than in the public recommendation. The user device 200 finally presents the customized recommendation with the new modified ratings to the user, in an action 2:5. For example, the user device may be configured to select the highest ranked items for presentation, e.g. the top 5 items or the like.

In this way, a customized recommendation can be achieved which is likely to be more relevant to this particular user as compared to the original public recommendation produced by the recommendation system 202, thanks to the weight information also provided from system 202. It should be noted that more than one user may use the device 200, e.g. by having different log-in data and different profiles. In that case, the different users will have different sets of private user data 200a to be used in actions 2:4, 2:4a depending on which user is currently logged on to the device.

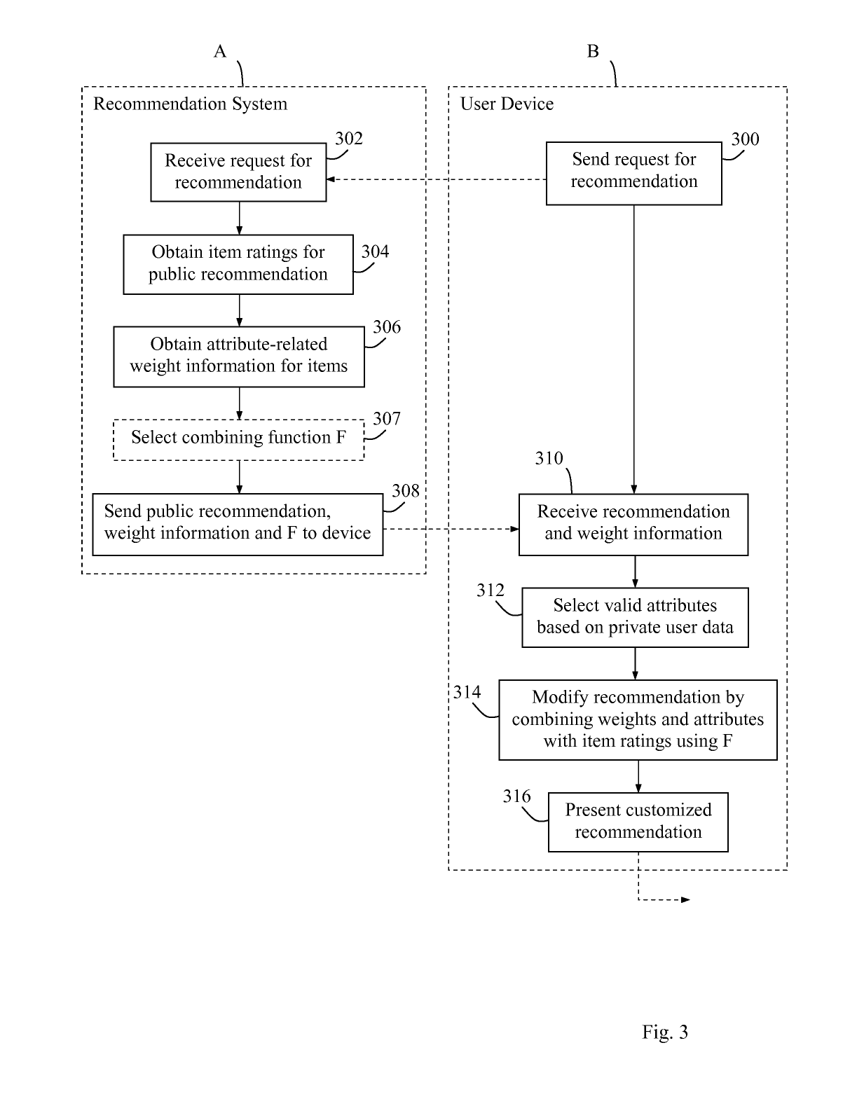

A procedure for enabling creation of a customized recommendation of items in a user device in communication with a recommendation system, will now be described with reference to FIG. 3. This procedure includes various steps or actions that may be executed in the recommendation system “A” and the user device “B” such as device 200 and system 202 in FIG. 2. In a first action 300, the user device sends a request for a recommendation of items and the request is received by the recommendation system in an action 302, basically corresponding to action 2:1 in FIG. 2. Again, this request may be omitted and the following procedure may be initiated otherwise at the recommendation system A.

The recommendation system A then obtains ratings of items for a public recommendation in a further action 304, basically corresponding to action 2:2a in FIG. 2. The ratings of items in the public recommendation may be determined based on public user data including at least one of: consumption logs and previously registered item ratings. In a further action 306, recommendation system A obtains attribute-related weight information for the items in the public recommendation, basically corresponding to action 2:2b in FIG. 2. The weight information thus comprises item-specific weight values for a plurality of predefined attributes pertaining to user characteristics, as explained above.

The recommendation system A may also select a combining function F to be used by the user device for determining new item ratings, in an optional action 307, basically corresponding to action 2:2c in FIG. 2. For example, the combining function F may be a straightforward multiplication of weight values for relevant attributes with the original item ratings of the public recommendation, although the combining function F may refer to any mathematic or logic operation for applying the relevant weight values to the original item ratings. This solution is thus not limited to any particular combining function F. The recommendation system A finally sends the ratings of items in the public recommendation together with the weight information to the user device, in an action 308 basically corresponding to action 2:3 in FIG. 2. Optionally, the recommendation system A may also include a combining function F in this action, unless the user device will instead use a known default function, as described above.

An action 310 in the user device B illustrates that it receives the information sent from the recommendation system A in action 308. The user device B will now modify the received public recommendation into a customized recommendation based on locally stored private user data and the received weight information, as follows.

In a following action 312, user device B selects valid attributes out of the predefined attributes in the received weight information based on the private user data being locally available in the device, basically corresponding to action 2:4a in FIG. 2. In other words, user device B determines, from the private user data of the current user of the device, which attributes of the predefined attributes in the received weight information are relevant or valid for that user, and selects these valid attributes and disregards the remaining non-relevant attributes.

User device B then modifies the public recommendation into a customized recommendation by combining the weights of the relevant attributes with item ratings using function F, in a further action 314. Differently expressed, user device B applies the weight values of the selected attributes in the weight information to the received ratings of items in the public recommendation according to function F. By only using weight values for attributes valid for the current user, new item ratings are obtained which have been adapted to the characteristics of this particular user. Device B finally presents the customized recommendation with the new item ratings in a further action 316. As described above, device B may present resulting personalized item ratings for just a limited number of items, e.g. including the most highly rated items.

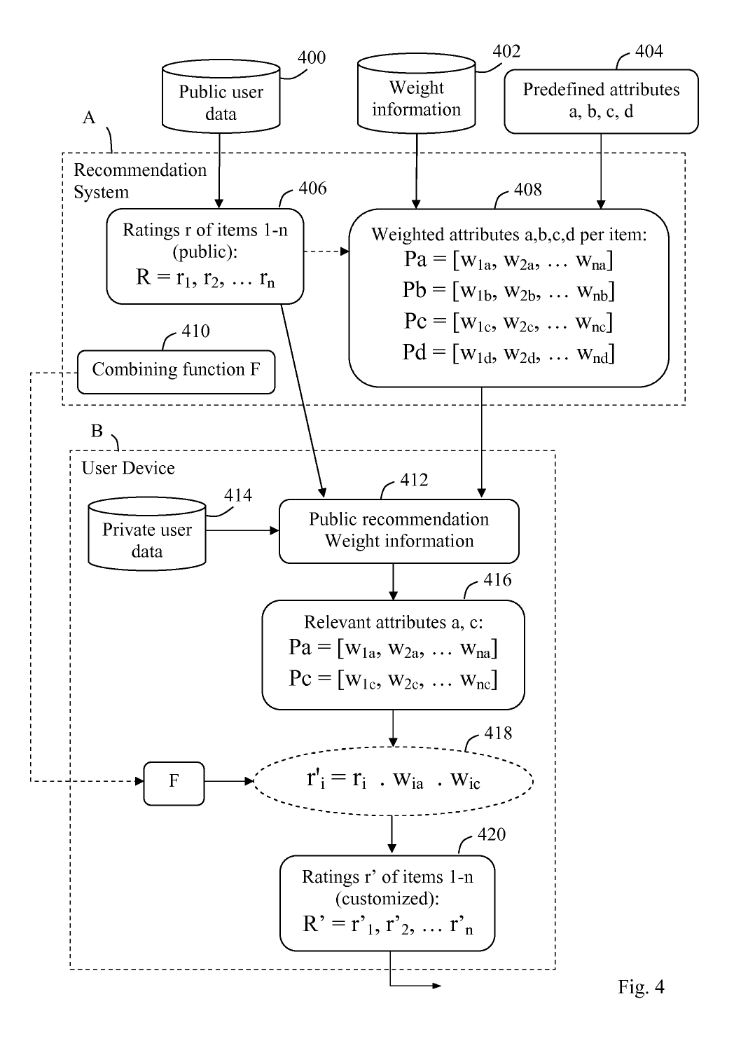

A more detailed but non-limiting example will now be described with reference to the block diagram in FIG. 4, for how different parameters can be used in a recommendation system A and a user device B, respectively, in a procedure to accomplish the above-described solution. This example may thus be employed in the above-described FIGS. 2 and 3 as well. The recommendation system A has access to a storage with public user data 400, a storage with weight information 402 and a set of predefined attributes 404 pertaining to different user characteristics, e.g. as exemplified above. In this simplified example, only four such attributes a, b, c, and d will be used, although any number of attributes may be used in practice for this solution which is not limited to any particular attributes.

First, the recommendation system A obtains ratings r of items 1-n for a public recommendation in a block 406 based on the public user data 400, which ratings are general and not user-specific. A limited selection of items may be used here, e.g. according to a certain item selection criterion as described above. These ratings are denoted:

R=r₁,r₂, . . . rₙ (1)

The recommendation system A then obtains attribute-related weight information 402 in a block 408 for those items 1-n and for those attributes a-d 404. The weight information thus comprises item-specific weight values w of each attribute for the rated items 1-n above. These weight values w for items 1-n can be represented by vectors Pa, Pb, Pc and Pd for the attributes a, b, c, and d, respectively, as:

Pa=[w₁ₐ,w₂ₐ, . . . wₙₐ]

Pb=[w_{1b},w_{2b}, . . . w_{nb}]

Pc=[w_{1c},w_{2c}, . . . w_{nc}]

Pd=[w_{1d},w_{2d}, . . . w_{nd}] (2)

The recommendation system A may also select or retrieve a predefined combining function F in a block 410, to be used by the user device, unless a known default combining function is used.

Next, the recommendation system A sends the public recommendation of block 406 with the ratings R and the weight information of block 408 with the vectors Pa, Pb, Pc and Pd to the user device B, optionally also including the combining function F of block 410. The user device B then determines and selects valid attributes out of the predefined attributes in the received weight information in a block 412, based on private user data available from a local storage 414 in the device. In this example, the user device determines from the private user data that only attributes a and c are valid and relevant for this particular user and that attributes b and d can be disregarded as non-valid or applicable for the user.

As a result, weight values of only the valid attributes a and c will be used for modifying the item ratings R in the public recommendation, i.e. the weight values wᵢₐ, w_{ic} found in vectors Pa and Pc for each item “i” as shown in a block 416. Next, user device B applies the weight values to the item ratings R of the public recommendation according to the combining function F in a block 418. In this simplified example, the function F is a straightforward multiplication of the weight values with the item ratings R, and this calculation is performed for each item i to produce a modified recommendation with new item ratings r′ as:

r′ᵢ=rᵢ·w₁ₐ·w_{ic} (3)

As mentioned above, the combining function F is not limited to a straightforward multiplication as of (3) in practice, but can be defined in any suitable manner.

In this way, a set of modified ratings R′ is obtained which can be used as a customized recommendation specifically adapted to the user of device B. The new ratings R′ are thus calculated for the items 1-n according to (3), the result being shown in a block 420, and can be denoted as:

R′=r′₁,r′₂, . . . r′ₙ (4)

The new ratings R′, or at least a selection thereof, are finally presented by the user device B, as indicated by the bottom arrow.

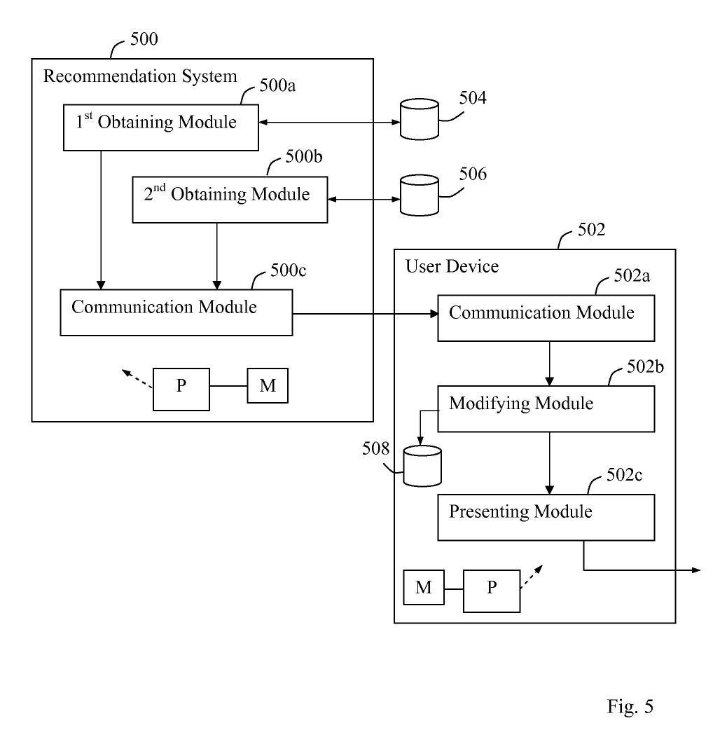

A detailed but non-limiting example of how arrangements can be implemented in a recommendation system 500 and a user device 502 to accomplish the above-described solution, is illustrated by the block diagram in FIG. 5. The recommendation system 500 is thus configured to enable creation of customized recommendations of items in the device 502, while the user device 502 is configured to create a customized recommendation of items, e.g. in the manner described above for any of FIGS. 2-4.

The arrangement in the recommendation system 500 comprises a first obtaining module 500a adapted to obtain ratings of items for a public recommendation, which may be determined based on public user data 504. The recommendation system arrangement 500 further comprises a second obtaining module 500b adapted to obtain attribute-related weight information 506 for said items, the weight information comprising item-specific weight values for a plurality of predefined attributes pertaining to user characteristics.

The recommendation system arrangement 500 also comprises a communication module 500c adapted to send the ratings of items in the public recommendation and the weight information to the user device 502. Thereby, the recommendation system 500 enables the user device 502 to modify the public recommendation into a customized recommendation based on locally stored private user data and said weight information.

The arrangement in the user device 502 comprises a communication module 502a adapted to receive from a recommendation system 500 ratings of items in a public recommendation and attribute-related weight information for said items, the weight information comprising item-specific weight values for a plurality of predefined attributes pertaining to user characteristics.

The user device arrangement 502 also comprises a modifying module 502b adapted to modify said public recommendation into a customized recommendation based on locally stored private user data 508 and said weight information. The user device arrangement 502 further comprises a presenting module 502c adapted to present the customized recommendation in a suitable manner to a user.

It should be noted that FIG. 5 merely illustrates various functional modules or units in the recommendation system 500 and the user device 502 in a logical sense, although the skilled person is free to implement these functions in practice using suitable software and hardware means. Thus, this aspect of the solution is generally not limited to the shown structures of the system 500 and the user device 502, while their functional modules 500a-500c and 502a-502c, respectively, may be configured to operate according to the features described for any of FIGS. 2-4 above, where appropriate.

The functional modules 500a-500c and 502a-502c described above can be implemented in the recommendation system 500 and the user device 502, respectively, as program modules of a respective computer program comprising code means which, when run by a processor “P” in each of the recommendation system 500 and the user device 502, causes the system 500 and the device 502 to perform the above-described functions and actions. The processor P may be a single CPU (Central processing unit), or could comprise two or more processing units. For example, the processor P may include general purpose microprocessors, instruction set processors and/or related chips sets and/or special purpose microprocessors such as ASICs (Application Specific Integrated Circuit). The processor P may also comprise a storage for caching purposes.

The computer program may be carried by a computer program product in each of the recommendation system 500 and the user device 502 in the form of a memory “M” connected to the processor P. The computer program product or memory M comprises a computer readable medium on which the computer program is stored. For example, the memory M may be a flash memory, a RAM (Random-access memory), a ROM (Read-Only Memory) or an EEPROM (Electrically Erasable Programmable ROM), and the program modules could in alternative embodiments be distributed on different computer program products in the form of memories within the recommendation system 500 and the user device 502.

The above notification server 500 and functional modules 500a-500c may be configured or adapted to operate according to various optional embodiments. For example, the first obtaining module 500a may be further adapted to determine the ratings of items in the public recommendation based on the public user data 504 including at least one of: consumption logs and previously registered item ratings.

In another possible embodiment, the communication module 500c is further adapted to also send a combination function F to the user device with the public recommendation and weight information, thereby enabling the user device to apply the weight values of selected attributes in said weight information to the received ratings of items according to the combination function F. The communication module 500c may be further adapted to send the public recommendation and weight information in response to a recommendation request received from the user device, such as the request in action 2:1 above. The first obtaining module 500a may also be adapted to select a limited set of items for the public recommendation based on their ratings or other suitable selection criterion, in order to facilitate the processing for the user device 502.

The above notification server 502 and functional modules 502a-502c may be configured or adapted to operate according to various optional embodiments as well. For example, the modifying module 502b may be further adapted to create the customized recommendation by selecting valid attributes out of said predefined attributes based on the private user data, and to apply the weight values of the selected attributes in the weight information to the received ratings of items. If a combination function F is received with said public recommendation from the recommendation system, the modifying module 502b may be further adapted to apply the weight values of the selected attributes in said weight information to the received ratings of items according to the received combination function F.

While the invention has been described with reference to specific exemplary embodiments, the description is generally only intended to illustrate the inventive concept and should not be taken as limiting the scope of the invention. For example, the terms “recommendation system”, “user device”, “items”, “item ratings”, “public user data”, “private user data”, “public recommendation”, “customized recommendation” and “weight information” have been used throughout this description, although any other corresponding nodes, functions, and/or parameters could also be used having the features and characteristics described here. The invention is defined by the appended claims.

1. A method in a recommendation system for enabling creation of a customized recommendation of items in a user device, the method comprising:
obtaining ratings of items for a public recommendation,
obtaining attribute-related weight information for said items, the weight information comprising item-specific weight values for a plurality of predefined attributes pertaining to user characteristics, and
sending the ratings of items in the public recommendation and the weight information to the user device,
wherein the user device is thus enabled to modify said public recommendation into a customized recommendation based on locally stored private user data and said weight information.

2. The method according to claim 1, wherein the ratings of items in the public recommendation are determined based on public user data including at least one of: consumption logs and previously registered item ratings.

3. The method according to claim 1, wherein a combination function F is also sent to the user device with the public recommendation and weight information, thereby enabling the user device to apply the weight values of selected attributes in said weight information to the received ratings of items according to the combination function F.

4. The method according to claim 1, wherein the attribute-related weight information has been determined by means of data mining or statistic analysis of user-specific information on consumed and rated items.

5. The method according to claim 1, wherein the public recommendation and weight information are sent in response to a recommendation request received from the user device.

6. The method according to claim 1, wherein a limited set of items are selected for the public recommendation based on their ratings.

7. An arrangement in a recommendation system configured to enable creation of customized recommendations of items for a user of a user device, the arrangement comprising:
a first obtaining module adapted to obtain ratings of items for a public recommendation,
a second obtaining module adapted to obtain attribute-related weight information for said items, the weight information comprising item-specific weight values for a plurality of predefined attributes pertaining to user characteristics, and
a communication module adapted to send the ratings of items in the public recommendation and the weight information to the user device,
thereby enabling the user device to modify said public recommendation into a customized recommendation based on locally stored private user data and said weight information.

8. The arrangement according to claim 7, wherein the first obtaining module is further adapted to determine the ratings of items in the public recommendation based on public user data including at least one of: consumption logs and previously registered item ratings.

9. The arrangement according to claim 7, wherein the communication module is further adapted to also send a combination function F to the user device with the public recommendation and weight information, thereby enabling the user device to apply the weight values of selected attributes in said weight information to the received ratings of items according to the combination function F.

10. The arrangement according to claim 7, wherein the attribute-related weight information has been determined by means of data mining or statistic analysis of user-specific information on consumed and rated items.

11. The arrangement according to claim 7, wherein the communication module is further adapted to send the public recommendation and weight information in response to a recommendation request received from the user device.

12. The arrangement according to claim 7, wherein the first obtaining module is further adapted to select a limited set of items for the public recommendation based on their ratings.

13. A method in a user device for creating a customized recommendation of items, the method comprising:
receiving from a recommendation system ratings of items in a public recommendation and attribute-related weight information for said items, the weight information comprising item-specific weight values for a plurality of predefined attributes pertaining to user characteristics,
modifying said public recommendation into a customized recommendation based on locally stored private user data and said weight information, and
presenting the customized recommendation.

14. The method according to claim 13, wherein the customized recommendation is created by selecting valid attributes out of said predefined attributes based on said private user data, and applying the weight values of the selected attributes in said weight information to the received ratings of items.

15. The method according to claim 14, wherein a combination function F is received with said public recommendation from the recommendation system, and the weight values of the selected attributes in said weight information are applied to the received ratings of items according to the received combination function F.

16. An arrangement in a user device configured to create a customized recommendation of items, the arrangement comprising:
a communication module adapted to receive from a recommendation system ratings of items in a public recommendation and attribute-related weight information for said items, the weight information comprising item-specific weight values for a plurality of predefined attributes pertaining to user characteristics,
a modifying module adapted to modify said public recommendation into a customized recommendation based on locally stored private user data and said weight information, and
a presenting module adapted to present the customized recommendation.

17. The arrangement according to claim 16, wherein the modifying module is further adapted to create the customized recommendation by selecting valid attributes out of said predefined attributes based on said private user data, and to apply the weight values of the selected attributes in said weight information to the received ratings of items.

18. The arrangement according to claim 17, wherein a combination function F is received with said public recommendation from the recommendation system, and the modifying module is further adapted to apply the weight values of the selected attributes in said weight information to the received ratings of items according to the received combination function F.
